(19) United States
(12) Patent Application Publication
(10) Pub. No.: US 2023/0323760 A1
(43) Pub. Date: Oct. 12, 2023

(54) PREDICTION OF WIRELINE LOGS USING ARTIFICIAL NEURAL NETWORKS

(71) Applicant: Saudi Arabian Oil Company, Dhahran (SA)

(72) Inventor: Aun Al Ghaithi, Dhahran (SA)

(21) Appl. No.: 17/715,860

(22) Filed: Apr. 7, 2022

(51) Int. Cl. E21B 43/16; E21B 43/26

(52) U.S. Cl. CPC E21B 43/16; E21B 43/26; E21B 2200/20; E21B 2200/22

(57) ABSTRACT

Methods and systems, including computer programs encoded on a computer storage medium are described for implementing a system that predicts wireline logs used in well drilling operations at a subsurface region. The system derives inputs from a first wireline log and includes a predictive model based on a neural network trained to generate data predictions. The predictive model processes the inputs derived from the first wireline log through layers of the neural network to generate a prediction that identifies multiple second wireline logs for a reservoir in the subsurface region. Based on the multiple second wireline logs, the system controls well drilling operations that simulate hydrocarbon production at the reservoir.

### TECHNICAL FIELD

This specification relates to reservoir characterization and wireline prediction for managing operations of wells in a subsurface region.

### BACKGROUND

Reservoir and production models can be used to monitor and manage the production of hydrocarbons from a reservoir. These models can be generated based on data sources including seismic surveys, other exploration activities, and production data. In particular, reservoir models based on data about the subterranean (or subsurface) regions can be used to support decision-making relating to field operations.

In reflection seismology, geologists and geophysicists perform seismic surveys to map and interpret sedimentary facies and other geologic features for applications such as identification of potential petroleum reservoirs. Seismic surveys can be conducted using a controlled seismic source (for example, a seismic vibrator or dynamite) to create a seismic wave.

In land-based seismic surveys, the seismic source is typically located at ground surface. The seismic wave travels into the ground, is reflected by subsurface formations, and returns to the surface where it is recorded by hardware sensors called geophones. Other approaches to gathering data about the subsurface, such as information relating to wells or well logging, can be used to complement the seismic data.

Existing methods for reservoir characterization can involve direct measurement of mechanical earth properties or static elastic moduli which often requires testing core samples in a lab setting. Further, these core samples represent only a limited part of the complete borehole coverage. Thus, improved methods for reservoir characterization are desirable to more effectively manage operations for production of hydrocarbons.

### SUMMARY

This specification describes techniques for implementing a system that predicts wireline logs used in well drilling operations at a subsurface region. The system derives inputs from one or more first wireline logs. These first wireline logs can include gamma ray and compressional slowness wireline logs. The system includes a predictive model that is based on a neural network trained to generate data predictions. The predictive model processes the inputs derived from the one or more first wireline logs through layers of the neural network to generate a prediction that identifies multiple second wireline logs. These second wireline logs include a predicted shear-slowness wireline log and a predicted bulk-density wireline log for a reservoir in the subsurface region. Based on at least the shear-slowness or the bulk density wireline logs, the system controls well drilling operations that simulate hydrocarbon production at the reservoir.

One aspect of the subject matter described in this specification can be embodied in a computer-implemented method for managing operations involving a well in a subsurface region using a neural network implemented on a hardware integrated circuit. The method includes deriving inputs from one or more first wireline logs; accessing a predictive model including a neural network trained to generate one or more data predictions; and processing, at the predictive model, the derived inputs through one or more layers of the neural network. The method further includes generating, by the predictive model, a prediction identifying multiple second wireline logs for a reservoir in the subsurface region based on the processing of the inputs; and controlling, based on the multiple second wireline logs, well drilling operations that simulate hydrocarbon production at the reservoir.

These and other implementations can each optionally include one or more of the following features. For example, in some implementations, generating the prediction identifying the multiple second wireline logs includes: generating a shear-slowness wireline log that is based on the one or more first wireline logs; and generating a bulk-density wireline log that is based on the one or more first wireline logs. In some implementations, the method further includes: computing, using the predictive model, characterizations of the reservoir in the subsurface region based on a predicted shear-slowness wireline log and a predicted bulk-density wireline log included among the multiple second wireline logs.

The method further includes: determining, by the predictive model, multiple earth properties for an area of the subsurface region that includes the reservoir; and determining, by the predictive model, a characteristic of the reservoir in the subsurface region based on the multiple earth properties. In some implementations, determining the multiple earth properties includes: calculating a set of mechanical earth properties based on at least one of the multiple second wireline logs; and calculating a set of elastic earth properties based on at least one of the multiple second wireline logs.

The set of mechanical earth properties and the set of elastic earth properties includes one or more of: a Young's modulus, a bulk modulus, a shear modulus, and a Poisons ratio. In some implementations, the method further includes: computing, from computed outputs of the predictive model, characterizations of the reservoir in the subsurface region based on at least one of: the set of mechanical earth properties; or the set of elastic earth properties. In some implementations, computing characterizations of the reservoir includes: identifying a stiffness of porous fluid saturated rocks at the reservoir based on the set of mechanical earth properties and the set of elastic earth properties.

In some implementations, identifying a stiffness of porous fluid saturated rocks at the reservoir includes: identifying the stiffness based on elastic moduli that identify stiffer rocks in unconventional oil and gas reservoirs. In some implementations, the method further includes: determining, using the predictive model, a placement location for a well drilling operation based on the computed characterizations of the reservoir. Controlling the well drilling operations includes: causing a hydraulic fracture at the placement location; and stimulating a particular type of hydrocarbon production at the reservoir in response to causing the hydraulic fracture at the placement location.

Other implementations of this and other aspects include corresponding systems, apparatus, and computer programs, configured to perform the actions of the methods, encoded on computer storage devices. A computing system of one or more computers or hardware circuits can be so configured by virtue of software, firmware, hardware, or a combination of them installed on the system that in operation cause the system to perform the actions. One or more computer programs can be so configured by virtue of having instructions that are executable by a data processing apparatus to cause the apparatus to perform the actions.

The subject matter described in this specification can be implemented to realize one or more of the following advantages. Relative to conventional approaches, the disclosed techniques can be used to more efficiently generate wireline logs that allow for calculating certain mechanical and elastic earth properties (e.g., elastic moduli). The described computational process of using artificial neural networks to predict wireline logs for managing drilling operations provides an accurate, repeatable automated approach that previously could not be performed by computer systems in an efficient manner.

The disclosed system leverages data driven methodologies and integrates a deep-learning neural network model that uses specific computational processes to predict shear and density wireline logs. During field operations poor quality reservoir data with missing wireline logs can cause inaccurate placement of hydraulic fractures and degrade well drilling operations. The deep-learning model accurately predicts missing wireline data for use in determining more optimal locations for hydraulic fractures.

For example, the predicted wireline logs are used to compute reservoir characterizations that are effective for identifying stiffer rocks in unconventional oil and gas reservoirs. These characterizations and identifications are then used to control well drilling operations that simulate hydrocarbon production at a given reservoir.

The details of one or more embodiments of these systems and methods are set forth in the accompanying drawings and the following description. Other features, objects, and advantages of these systems and methods will be apparent from the description and drawings, and from the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic view of a seismic survey being performed to map subterranean features such as facies and faults.

FIG. 2 illustrates an example computing system for predicting wireline logs using an artificial neural network.

FIG. 3 shows an example process for predicting wireline logs using a neural network model.

FIG. 4A shows an example process for preprocessing a dataset used to train an example neural network data model.

FIGS. 4B and 4C show examples of a preprocessed dataset used to train an example neural network data model.

FIG. 5 shows an example process for predicting wireline logs for reservoir characterization.

FIG. 6A shows an example feature engineering process.

FIG. 6B shows a heat map with computed correlation coefficients and FIG. 6C shows an example dataset derived from a feature engineering process.

FIG. 7 shows an example data splitting process.

FIG. 8 shows an example process for model training and selection.

FIG. 9A shows an example process associated with generating a neural network model.

FIG. 9B illustrates an example normalized mean squared error loss curve from training a neural network.

FIG. 10 illustrates an example feed forward neural network architecture.

FIG. 11A illustrates example graphical data from a representative blind well test.

FIG. 11B illustrates example graphical data from a representative blind well test for shear log predictions.

FIGS. 12A and 12B illustrate example graphical data from a representative blind well tests for bulk density log predictions.

FIGS. 13A and 13B illustrate example graphical representation of data used to generate one or more machine-learning predictions.

FIGS. 14A and 14B illustrate example machine-learning predictions generated for one or more log datasets.

FIG. 15 is a block diagram illustrating an example computer system used to provide computational functionalities associated with described algorithms, methods, functions, processes, flows, and procedures according to some implementations of the present disclosure.

Like reference numbers and designations in the various drawings indicate like elements.

### DETAILED DESCRIPTION

The disclosure is directed to a technique for predicting shear slowness logs and bulk-density wireline logs from at least one gamma ray log and at least one compressional slowness log. The gamma ray and compressional slowness logs are provided as inputs to an artificial neural network (ANN) that is trained on data points derived for hundreds of wells. The training is used to develop a predictive model that is operable to predict shear slowness logs and bulk-density wireline logs from one or more inputs. The predictive model is based on a particular neural network architecture, including unique parameters and model weights of the neural network.

The predictive model uses the gamma ray and compressional slowness logs inputs to calculate mechanical or elastic earth properties that are used to perform characterizations on a reservoir in a subsurface region. The predictive model can generate shear slowness logs and bulk-density wireline logs for identifying a stiffness of porous fluid saturated rocks. For example, the generated logs can include elastic moduli for identifying stiffer rocks in unconventional oil and gas reservoirs. A system that includes the predictive model can use at least the elastic moduli and identified stiffer rocks to determine where to place hydraulic fractures to stimulate oil and gas flow in tight reservoirs.

Gamma ray logging involves measuring naturally occurring gamma radiation to characterize rocks or sediment in a borehole or drill hole. Gamma ray wireline logs can measure natural radioactivity in formations and can be used for identifying lithologies and for correlating zones in a subsurface region. Compressional slowness wireline logs include data indicating compressional wave velocity measured in the borehole and can be obtained using techniques for recording compressional slowness in a formation based on the transit time between transmitter and receiver. Compressional slowness relates to an elastic body wave or sound wave, such as a P-wave, where particles oscillate in a direction the wave propagates.

Shear slowness logs include data indicating shear wave slowness or velocity and involve use of a shear-wave source rather than a compressional-wave source. In contrast to P-waves, shear waves (S-waves) are an elastic body wave in which particles oscillate perpendicular to the direction in which the wave propagates. In some implementations, P-waves that impinge on an interface at non-normal incidence can produce S-waves and the predictive model can account for, and leverage, this to predict shear slowness logs from at least a compressional slowness log. Shear waves travel through the Earth at about half the speed of compressional waves and respond differently to fluid-filled rock, and so can provide different, additional information about lithology and fluid content of hydrocarbon-bearing reservoirs.

Bulk-density wireline logging involves an application of gamma rays in gathering data about subsurface formations. Bulk-density wireline logs can indicate overall bulk density as a function of the density of minerals forming a rock, i.e., a matrix, and fluids (water, oil, gas) enclosed in the pore spaces of the subsurface formation. Obtaining data for generating bulk-density wireline logs can include use of a gamma ray source that irradiates a stream of gamma rays into the formation. The gamma rays may be absorbed, passed through the matrix, scattered, or a combination of these. The predictive model can account for, and leverage, these gamma rays characteristics when predicting bulk-density logs using at least the gamma ray wireline logs.

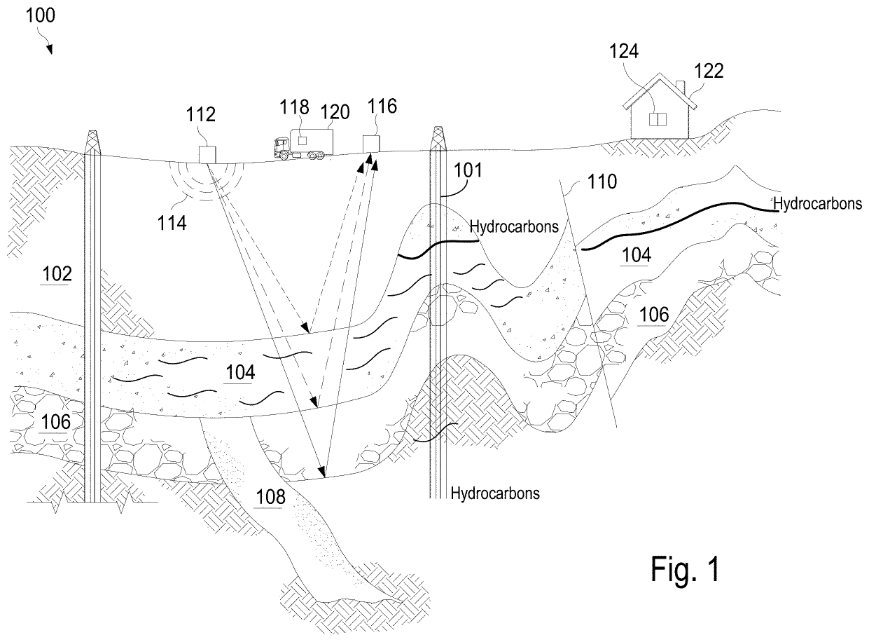

FIG. 1 is a schematic view of activities being performed to map subterranean features such as facies and faults in a subterranean formation 100. FIG. 1 shows an example of acquiring seismic data using an active source 112. This seismic survey can be performed to obtain seismic data (such as acoustic data) used to generate a depth map in the subterranean formation 100. The subterranean formation 100 includes a layer of impermeable cap rock 102 at the surface. Facies underlying the impermeable cap rocks 102 include a sandstone layer 104, a limestone layer 106, and a sand layer 108. A fault line 110 extends across the sandstone layer 104 and the limestone layer 106.

Oil and gas tend to rise through permeable reservoir rock until further upward migration is blocked, for example, by the layer of impermeable cap rock 102. Seismic surveys attempt to identify locations where interaction between layers of the subterranean formation 100 are likely to trap oil and gas by limiting this upward migration. For example, FIG. 1 shows an anticline trap 107, where the layer of impermeable cap rock 102 has an upward convex configuration, and a fault trap 109, where the fault line 110 might allow oil and gas to flow in with clay material between the walls traps the petroleum. Other traps include salt domes and stratigraphic traps.

In some contexts, such as shown in FIG. 1, an active seismic source 112 (for example, a seismic vibrator or an explosion) generates seismic waves 114 that propagate in the earth. Although illustrated as a single component in FIG. 1, the source or sources 112 are typically a line or an array of sources 112. The generated seismic waves include seismic body waves 114 that travel into the ground and seismic surface waves that travel along the ground surface and diminish as they get further from the surface.

The seismic waves 114 are received by a sensor or sensors 116. Although illustrated as a single component in FIG. 1, the sensor or sensors 116 generally include one to several three-component sensors that are positioned near an example wellhead. The sensors 116 can be geophone-receivers that produce electrical output signals transmitted as input data, for example, to a computer 118 on a control truck 120. Based on the input data, the computer 118 may generate data outputs, for example, a seismic two-way response time plot or data production data associated wellsite operations. In some cases, the control truck 120 is an extension of a production system that is used to monitor and manage the production of hydrocarbons from a reservoir.

A control center 122 can be operatively coupled to the control truck 120 and other data acquisition and wellsite systems. The control center 122 may have computer facilities for receiving, storing, processing, and analyzing data from the control truck 120 and other data acquisition and wellsite systems that provide additional information about the subterranean formation. For example, the control center 122 can receive data from a computer associated with a well logging unit. For example, computer systems 124 in the control center 122 can be configured to analyze, model, control, optimize, or perform management tasks of field operations associated with development and production of resources such as oil and gas from the subterranean formation 100.

Alternatively, the computer systems 124 can be located in a different location than the control center 122. Some computer systems are provided with functionality for manipulating and analyzing the data, such as performing data interpretation or borehole resistivity image log interpretation to identify geological surfaces in the subterranean formation or performing simulation, modeling, data integration, planning, and optimization of production operations of the wellsite systems.

In some embodiments, results generated by the computer systems 124 may be displayed for user viewing using local or remote monitors or other display units. One approach to analyzing data related to production operations is to associate a particular subset of the data with portions of a seismic cube representing the subterranean formation 100. The seismic cube can also be display results of the analysis of the data subset that is associated with the seismic survey. The results of the survey can be used to generate a geological model representing properties or characteristics of the subterranean formation 100.

The models and control systems can automatically acquire production data (e.g., gas and liquid production rates, flowing wellhead pressure (FWHP), flowing wellhead temperature). In some implementations, these models and systems can be configured to acquire measured production data in real-time, including surface measured production. For example, the production data can be acquired at a dynamic or user-defined rate, such as hourly, daily, or weekly. The models and control systems can automatically acquire data corresponding to depth logs, gamma ray logs, and compressional sonic wireline logs.

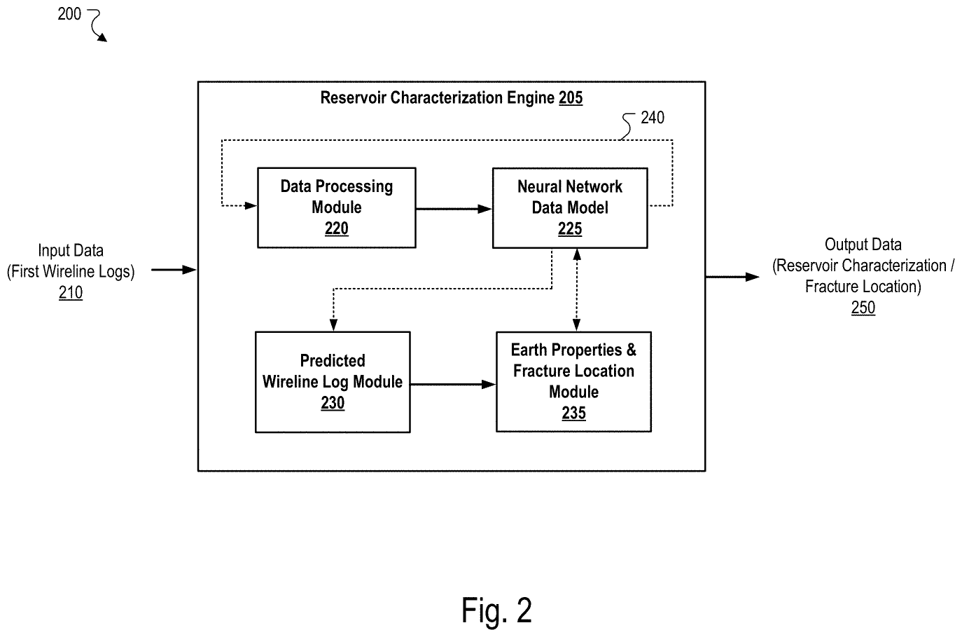

FIG. 2 illustrates an example computing system for predicting wireline logs using an artificial neural network.

Wireline logging is the process of using instruments (e.g., electronic instruments) to continuously measure the properties of a formation, for example, to make decisions about drilling and production operations. In wireline logging, operations can involve obtaining measurements of downhole formation attributes using special tools or equipment that are lowered into a borehole. For example, a sonde (or other related tooling) is gradually pulled out of the hole and a device or system coupled to the sonde can record properties of the formation rocks and any associated with fluids. In general, the sonde or related tooling/device can be an instrument probe that automatically transmits information about its surroundings from an inaccessible location, such as underground or underwater.

The system 200 includes a reservoir characterization engine 205 that processes sets of input data 210 to generate output data 250. The input data 210 includes one or more wireline logs, such as gamma ray and compressional slowness wireline logs, whereas the output data 250 is a prediction (for example, a predicted parameter or property) or characterization that is specific to a reservoir, a subsurface region, a well or borehole, or a combination of these.

The input data 210 can include a training dataset, a dataset for pre-processing before being used as inputs to a machine-learning computation, or a set of neural network inputs to be processed through layers of an example neural network implemented at the reservoir characterization engine 205. In some cases, the input data 210 can include a set of candidate features or a dataset from which candidate features are derived. In some other cases, the set of candidate features are curated and refined via a feature engineering process that is executed using the reservoir characterization engine 205.

The output data 250 can include a characterization of a reservoir, a characterization of a subsurface region that includes a reservoir, a placement location for a well drilling operation, a candidate fracture location for stimulation and production of hydrocarbons, or a combination of these. In some implementations, the output data 250 is used to manage operations of a one or more wells, such as an oil or gas producing well.

In some implementations, the reservoir characterization engine 205 is utilized as an automated application for subsurface and reservoir evaluation as well as for augmenting or enhancing well operations for hydrocarbon production. For example, the reservoir characterization engine 205 can be used to predict missing or poor quality shear and bulk density wireline logs. In some cases, the predicted wireline logs are used in geo-mechanical studies, fracture characterization, history matching, rock physics analysis, and seismic inversion analysis.

The reservoir characterization engine 205 uses shear logs and bulk density logs for various seismic data applications, such as amplitude-variation-with-offset (AVO) inversion and multicomponent seismic interpretation. In general, AVO seismic inversion has been used extensively in hydrocarbon exploration. More specifically, AVO inversion is a seismic exploration methodology used to predict the earth's elastic parameters and thus rocks and fluid properties. Shear and density wireline logs are also used in rock physics templates, to generate detailed mappings for reservoir porosity intervals as well as to differentiate reservoir lithology. In some cases, shear logs are also used to calculate velocity ratio, which is used for gas detection and mapping reservoir pay zones.

System 200 and the reservoir characterization engine 205 may be included in the computer system 124 described earlier with reference to FIG. 1. For example, each of system 200 and the reservoir characterization engine 205 can be included in the computer system 124 as a sub-system of hardware circuits, such as a special-purpose circuit, that includes one or more processor microchips.

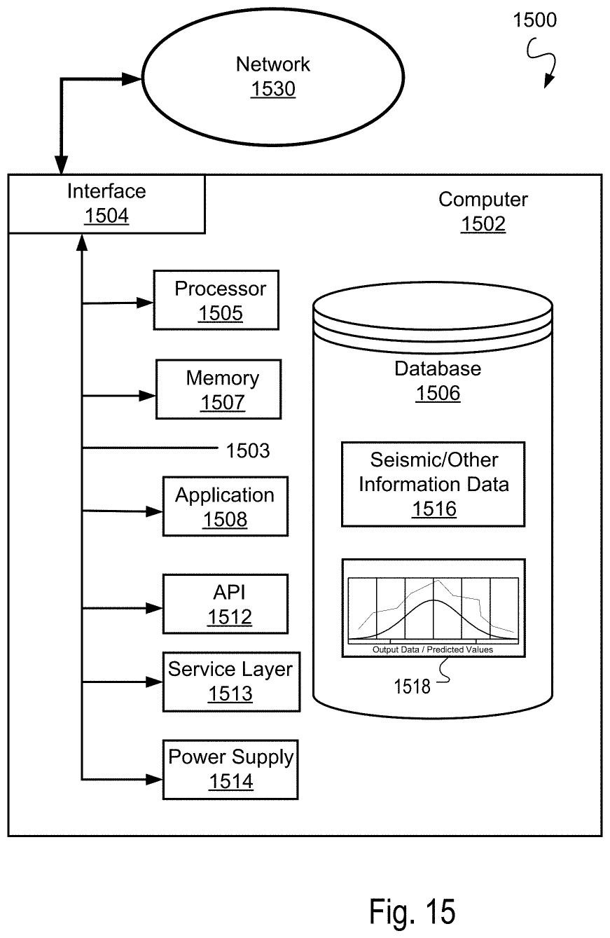

Although a single reservoir characterization engine 205 is shown in the example of FIG. 2, in some cases the computer systems 124 can include multiple reservoir characterization engines 205 as well as multiple systems 200. Each of the reservoir characterization engines 205 can include processors, for example, a central processing unit (CPU) and a graphics-processing unit (GPU), memory, and data storage devices. Each of system 200 and the reservoir characterization engine 205 can also be included in a computer system 1500, which is described later with reference to FIG. 15.

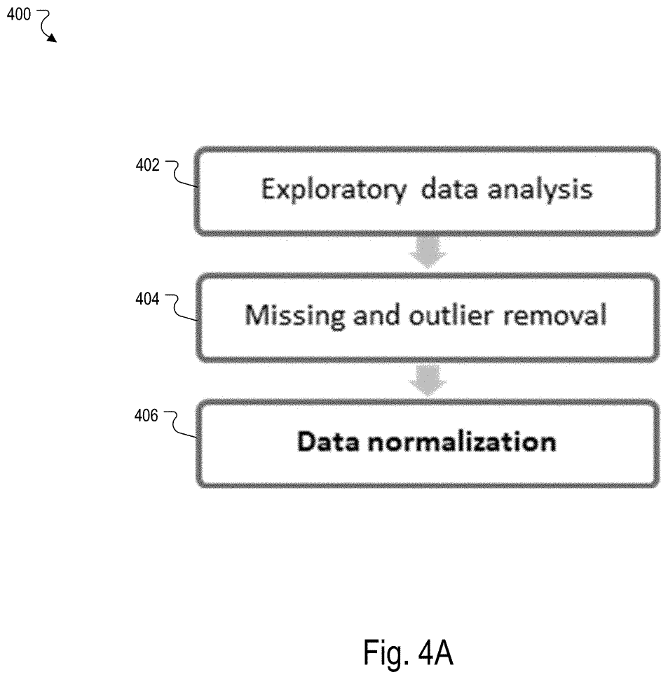

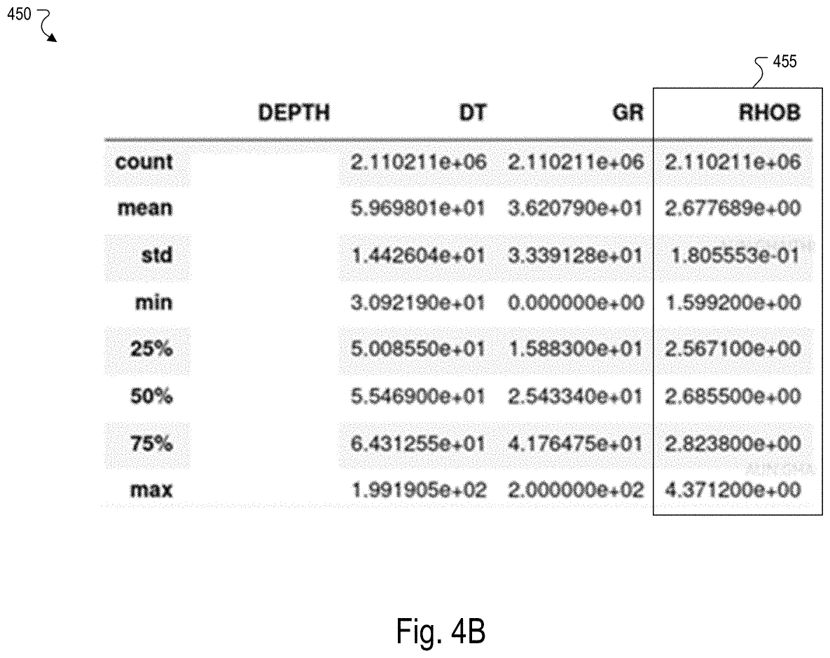

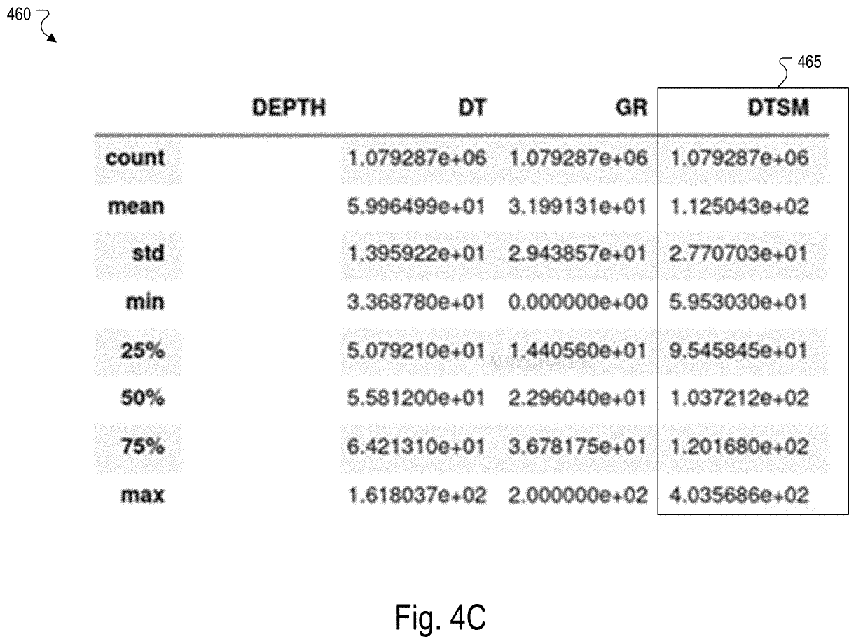

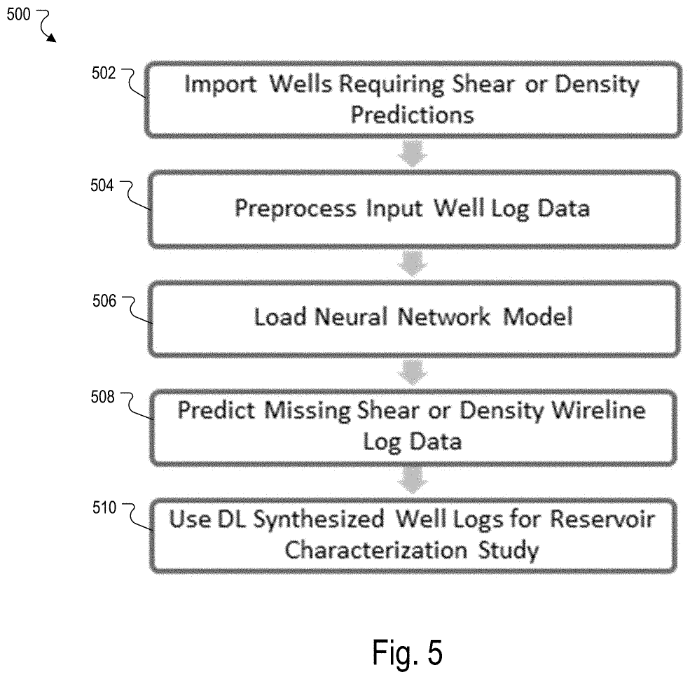

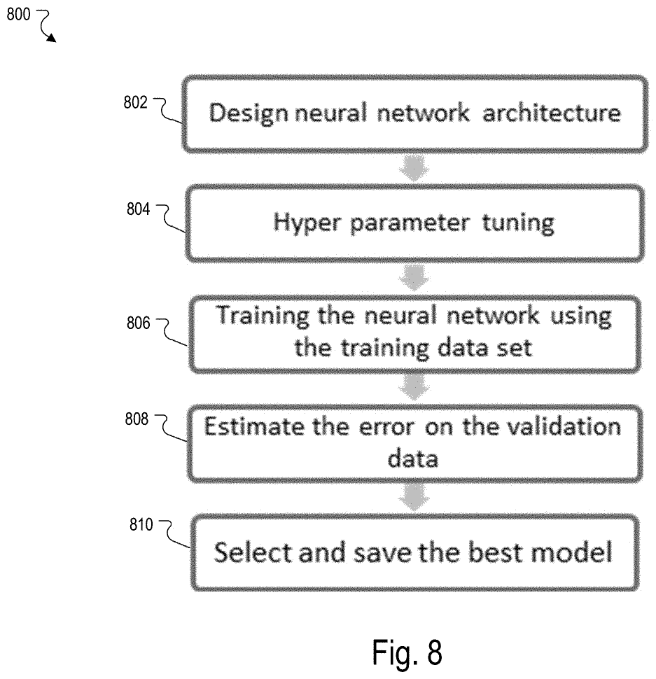

The reservoir characterization engine 205 includes a data processing module 220, a neural network data model 225 (“NN data model 225”), a predicted wireline log module 230 (“predicted log module 230”), and an earth properties & fracture location module 235 (“earth properties module 235”). Each of the data processing module 220, the NN data model 225, the predicted log module 230, and the earth properties module 235 can be implemented in hardware, software, or both. The data processing module 220 is described at least with reference to the example of FIG. 4A. The NN data model 225 is described at least with reference to the examples of FIGS. 8-10. The predicted log module 230 is described at least with reference to the example of FIG. 5.

The earth properties module 235 represents an example application or program generating reservoir characterization outputs base on one or more inputs. In some implementations, the earth properties module 235 interacts with the NN data model 225 to obtain one or more outputs of an earth data model that models certain surface formations. For example, the earth properties module 235 is operable to obtain and process data corresponding to a geo-mechanical earth model to generate determinations regarding well placement and fracture locations.

In some implementations, the earth properties module 235 uses aspects of the geo-mechanical earth model to compute output data 250 for enhancing effectiveness of well-drilling operations, expediting timelines for well completions, initiating hydraulic fracturing, and stimulating production from unconventional oil and gas reservoirs. The earth properties module 235 is also described later at least with reference to the example of FIGS. 4A-4C.

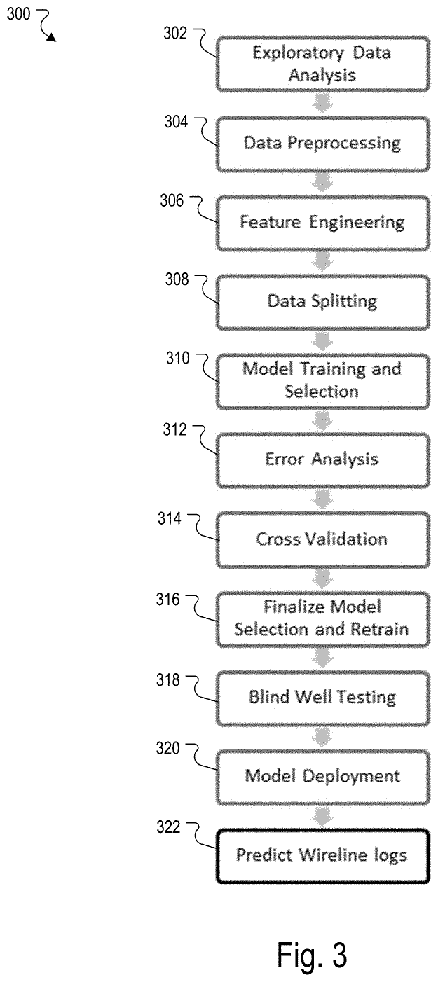

FIG. 3 shows an example process 300 for predicting wireline logs using a neural network model. In at least one example, the blocks of process 300 represent process steps for a deep-learning workflow, such as an automated workflow, for wireline log prediction. Process 300 provides a methodology that is used for shear sonic and bulk density well log predictions.

Process 300 can be implemented or executed using the computer systems 124 and the reservoir characterization engine 205 of a system 200. Hence, descriptions of process 300 may reference the computing resources of computer systems 124 and the reservoir characterization engine 205 described earlier in this document. In some implementations, the steps or actions included in process 300 are enabled by programmed firmware or software instructions, which are executable by one or more processors of the devices and resources described in this document.

Process 300 includes performing exploratory data analysis (302). For example, the exploratory data analysis is first carried out to determine or confirm the availability of a sufficient quantity of datasets (e.g., big datasets). The exploratory data analysis used to scan the inputs and parameter values of one or more datasets to determine if the datasets are of sufficiently good quality use as inputs to machine-learning that leverages deep-learning algorithms to train an example neural network model.

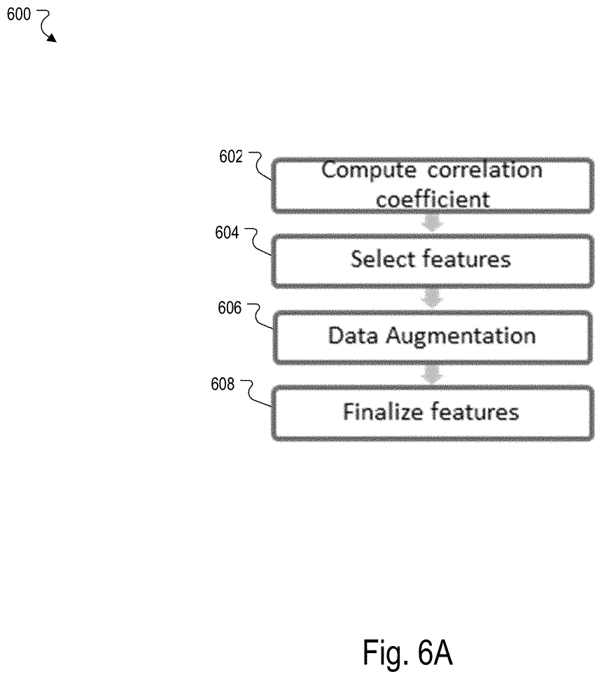

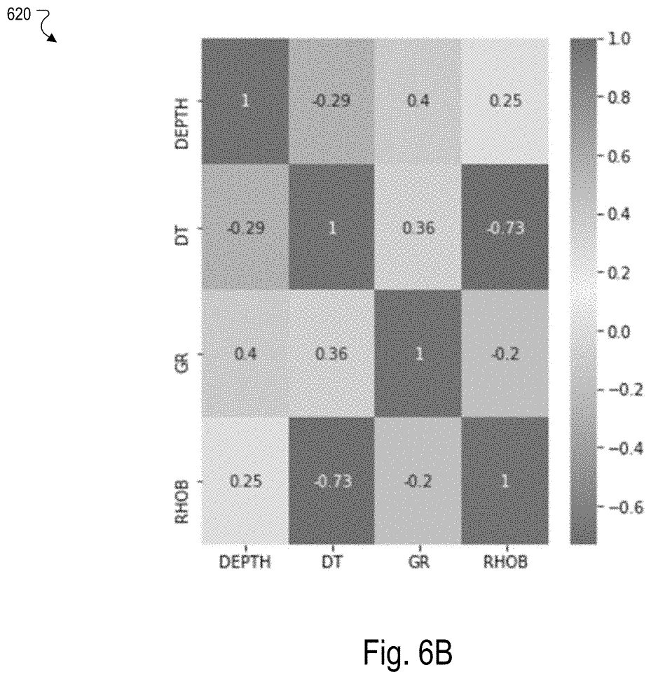

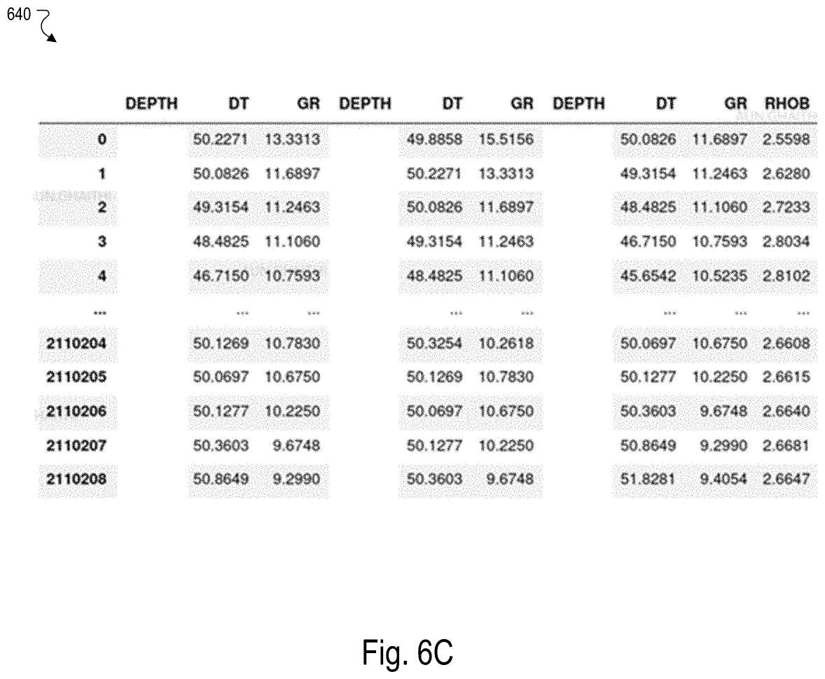

Process 300 includes performing data preprocessing (304). For example, the datasets upon which exploratory data analysis is performed at then preprocessed in preparation for the deep-learning operations. The data preprocessing operation is described in more detail later at least with reference to the example of FIG. 4A. Process 300 includes a feature engineering operation (306). For example, feature engineering may be conducted to select appropriate wireline logs for generating various output predictions. The reservoir characterization engine 205 can perform feature engineering to derive one or more sets of features from a given dataset, such as from a preprocessed dataset. In some implementations, the reservoir characterization engine 205 is operable to perform feature engineering either concurrent with, or in addition to, the pre-processing operations. The feature engineering operation(s) is described in more detail later at least with reference to the example of FIG. 6A.

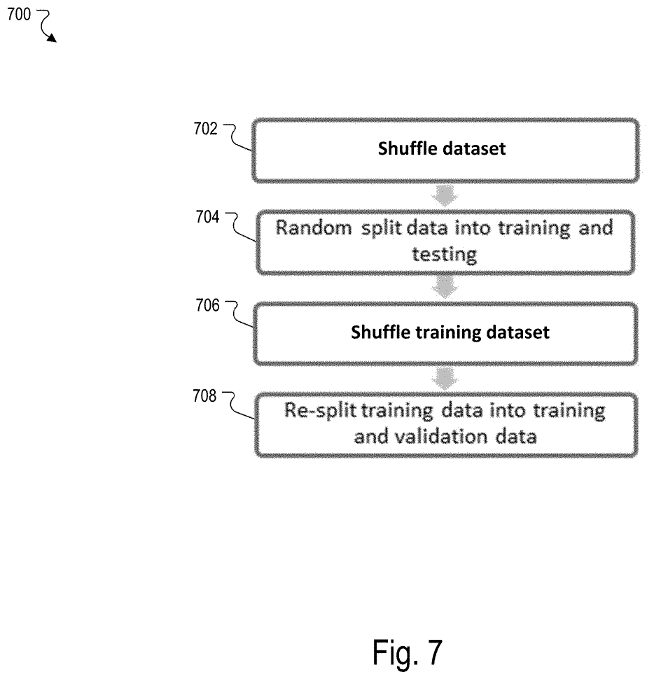

The process 300 includes an example data splitting operation (308). For example, datasets for deep-learning operations can be split into: i) training data, ii) hold-out validation data, and iii) blind testing data. The data splitting operation is described in more detail later with reference to the example of FIG. 7. The process 300 includes an example model training & selection operation (310). In some implementations, this operation is used to design, determine, or otherwise select an example neural network architecture. The reservoir characterization engine 205 can then tune hyperparameters of the selected neural network architecture during an example training phase.

The process 300 includes an example error analysis operation (312). The reservoir characterization engine 205 can perform the error analysis against one or more of the datasets that are derived from the data splitting operation. For example, reservoir characterization engine 205 can perform error analysis on prediction outputs obtained using validation data such that the error outputs are estimated on the hold-out validation dataset.

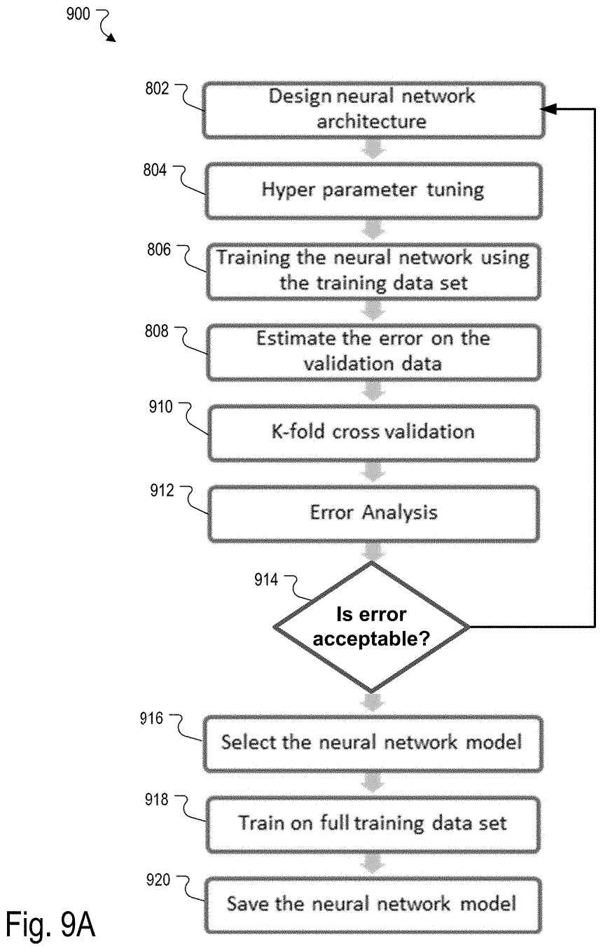

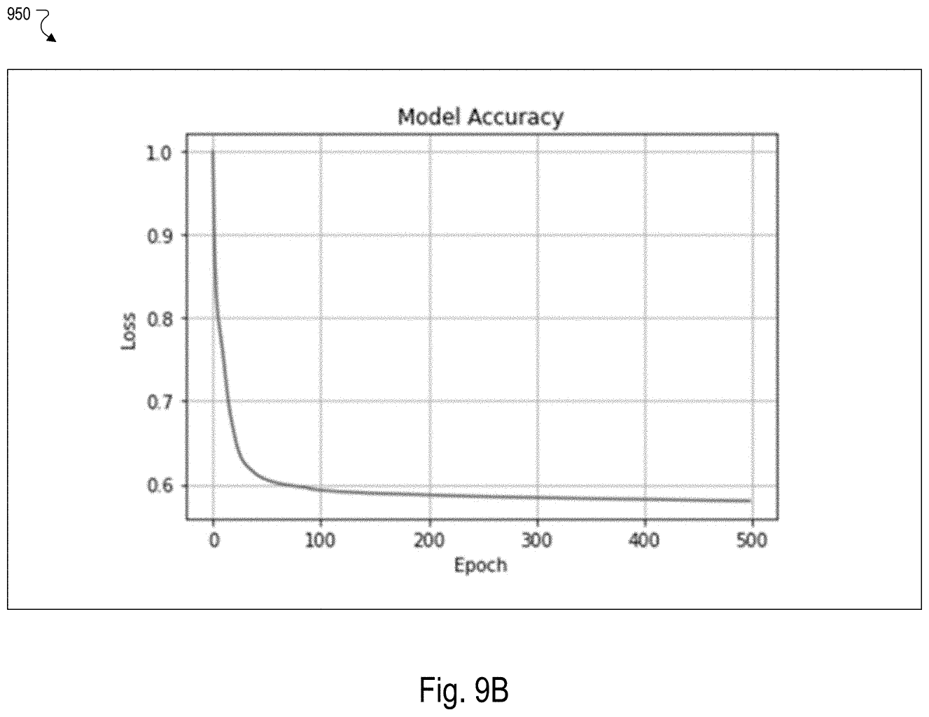

The process 300 includes an example cross validation operation (314). The reservoir characterization engine 205 performs cross validation to ensure the neural network model is robust in its performance. For example, the reservoir characterization engine 205 can perform cross validation to ensure that prediction performance of a trained neural network model meets or exceeds a certain threshold performance level. The cross validation operation is described in more detail later with reference to the example of FIG. 9.

The process 300 includes an example model selection and retraining operation (316). This operation can be used to finalize selection of a particular neural network model as well as to initiate training (or retraining) of a given neural network model. For example, when the reservoir characterization engine 205 finalizes selection of a neural network model, the model is then trained on a training dataset, such as a full (or partial) training dataset. Selection and training of neural network models are described in more detail later at least with reference to the example of FIG. 8.

The process 300 includes blind well testing operations (318). Following training of a selected neural network model, the model is then tested to evaluate or assess its performance. For example, the evaluation includes performing blind well testing. The blind well testing provides an additional, broader measure of performance validation to further validate overall performance of a given neural network model. For example, the blind well testing approach gives a reliable estimate or indication of model generalization and model performance specific to datasets it has not seen before.

The selected model can be tested (or retested) on a blind well dataset to analyze the model generalization performance. In some implementations, to measure the selected neural network model's generalization ability, the model is deployed on blind well tests that are equivalent to approximately 10% of the original dataset. In some cases, varying percentages can be used, such as 8% or 15%. The disclosed computer systems 124, 1500 can be used to perform, for example, 33 blind well tests for bulk density wireline log predictions and 17 blind well tests for shear wireline log predictions.

The process 300 includes performing model deployment (320). The reservoir characterization engine 205 uses the deployed model to predict one or more wireline logs (322). In some implementations, the model is deployed and used to synthesize missing or poor-quality shear sonic and bulk density wireline logs based on its data processing operations and its computed predictions. The characterization engine 205 can be generate these predictions in an automated manner, based on user input, or both.

For example, based on input data 210 associated with a reservoir, a geoscientists or engineer seeking to perform characterization of that reservoir can use the reservoir characterization engine 205 to generate predictions indicating elastic wireline logs, such as compressional sonic, shear sonic, and bulk density logs). The reservoir characterization engine 205 can also use that predictions to compute dynamic mechanical properties of reservoir rocks, such as bulk modulus, Young's modulus, shear modulus, and Poisson's ratio.

FIG. 4A shows an example process 400 for preprocessing a dataset used to train an example neural network data model.

Process 400 is implemented or executed using the reservoir characterization engine 205 of system 200, and may also include use of computer systems 124. More specifically, one or more steps of process 400 are performed using data processing module 220. Hence, descriptions of process 400 reference at least data processing module 220, and may also reference the computing resources of computer systems 124, as well as the other resources of the reservoir characterization engine 205 described earlier in this document. In some implementations, the steps or actions included in process 400 are enabled by programmed firmware or software instructions, which are executable by one or more processors of the devices and resources described in this document.

Process 400 includes performing exploratory data analysis one or more datasets (402). For example, the reservoir characterization engine 205 can obtain/import some (or all) available well log datasets for a given field or geographic region. The data processing module 220 can analyze the imported datasets to determine whether the datasets include input and output pairs that are sufficient for machine learning training. For example, the input and output pairs can include compressional sonic logs, shear sonic logs, gamma ray logs, and the depth logs.

FIGS. 4B and 4C show examples of a preprocessed dataset used to train a neural network data model.

More specifically, the example of FIG. 4B shows a well log dataset 450 used for prediction of bulk density wireline logs. For example, the well log dataset 450 can be used or processed as input data 210 to generate bulk density wireline logs prediction. In some implementations, well log dataset 450 represents summary statistics of a well log dataset after a preprocessing operation is performed on the dataset to remove missing and outlier data (404). In some implementations, the data processing module 220 identifies or determines outlier values based on domain knowledge of petrophysical values, readings for anticipated formations and zones, or both. The inventory of dataset 450 includes example measured data values for depth, compressional sonic log (DT) and gamma ray log (GR). The inventory of dataset 450 also includes bulk density log (RHOB) (455).

In some implementations, reservoir characterization engine 205 trains its artificial neural networks using an example supervised machine learning approach that requires example data points for a bulk density wireline log to be present. Thus, the RHOB values (455) can represent a set of labelled inputs that are processed through layers of the neural network in accordance with an example supervised machine learning algorithm. An example dataset 450 can include more than 2.1 million data values/points. In some examples, fewer than 2.1 million data points are used. In general, dataset 450 is constructed to provide a robust dataset that is sufficiently large so as to aid a neural network in optimal learning and establishing of data connections to generate more accurate predictions for density wireline log.

The example of FIG. 4C shows a well log dataset 460 used for predicting of shear wireline logs. For example, the well log dataset 460 can be used or processed as input data 210 to generate various shear wireline logs prediction. In some implementations, well log dataset 460 represents summary statistics of a well log dataset after a preprocessing operation is performed on the dataset to remove missing and outlier data (404). For example, to generate shear predictions the data processing module 220 can compute Poisson's ratio as a preprocessing operation. The computed Poisson's ratio is used to remove outlier data in the well log dataset 460 based on meaningful cutoff values.

Following removal of missing and outlier values (data cleaning) at the datasets, the data processing module 220 can perform data normalization to normalize values of the datasets (406). For example, to implement data normalization, each sample in the datasets can be transformed to have values that between 0 and 1. In some cases, the values may include 0 and 1. In some implementations, performing the data normalization is a required step to train a neural network. The inventory of dataset 460 includes example measured data values for depth, compressional sonic log (DT) and gamma ray log (GR). The inventory of dataset 460 also includes shear sonic log (DTSM) (455).

As discussed earlier, reservoir characterization engine 205 can train its artificial neural networks using an example supervised machine learning approach, which requires example data points for a shear sonic wireline log to be present. Thus, the DTSM values (465) can represent a set of labelled inputs that are processed through layers of the neural network in accordance with an example supervised machine learning algorithm. An example dataset 460 can include 1 million data samples. In some examples, more or fewer than 1 million data samples are used. In general, dataset 460 is constructed to provide a robust dataset that is sufficiently large so as to aid a neural network in optimal learning and establishing of data connections to generate more accurate predictions for the shear wireline log.

FIG. 5 shows an example process 500 for predicting wireline logs for reservoir characterization. Process 500 is implemented or executed using the reservoir characterization engine 205 of system 200, and may also include use of computer systems 124 as well as computer system 1500. Hence, descriptions of process 500 reference at least reservoir characterization engine 205, and may also reference other compute resources and systems described in this document. In some implementations, the steps or actions included in process 500 are enabled by programmed firmware or software instructions, which are executable by one or more processors of the devices and resources described in this document.

In some implementations, process 500 represents a method for managing operations involving a well in a subsurface region using a neural network implemented on a special-purpose hardware integrated circuit. Process 500 includes importing wells that require shear or density predictions (502). For example, the reservoir characterization engine 205 can import data describing wells that require shear or density predictions as input data 210. In some implementations, the reservoir characterization engine 205 derives multiple inputs from a first wireline log, such as depth log, gamma ray log, and compressional sonic wireline log. The derived inputs can be processed as input data 210 and may be discrete data samples (e.g., individual numerical value) of a given wireline log.

Process 500 includes preprocessing the input well log data (504). For example, the reservoir characterization engine 205 can preprocess the imported well log data using one or more of the data processing functions and operations described earlier with reference to FIG. 4. In some implementations, the reservoir characterization engine 205 derives multiple inputs from a first wireline log based on a preprocessing operation performed by the data processing module 220.

The reservoir characterization engine 205 is operable to load or access one or more neural network predictive models (506). For example, the reservoir characterization engine 205 can include multiple neural network models that are trained and/or optimized to perform various predictive and/or inference. In some implementations, the reservoir characterization engine 205 engine includes a neural network model that is trained as a feature generator configured to generate a curated feature set. For example, the feature set may be optimized for training a second, different neural network model to accurately (or more accurately) generate shear wireline log and bulk density predictions.

To train this (and other) neural network(s), the reservoir characterization engine 205 can employ one or more deep-learning algorithms. In general, neural networks that are trained based on a deep-learning approach include a threshold number of node layers, or depth, such that the compute benefits of the deep-learning approach may be appropriately leveraged. In some cases, a trained version of this second, different neural network model is among the one or more data models loaded by the reservoir characterization engine 205.

The reservoir characterization engine 205 use its neural network models to predict missing shear or density wireline log data (508). The process 500 includes using deep-learning (DL) synthesized well logs for reservoir characterization studies (510). For example, the reservoir characterization engine 205 utilizes the neural network data models 225 and the predicted log module 230 to generate the DL synthesized well logs. The reservoir characterization engine 205 can pass the DL synthesized well logs to the earth properties module 235 for further processing. In some implementations, the reservoir characterization engine 205 executes compute logic of the earth properties module 235 to perform various types of reservoir characterization studies and generate output data 250 corresponding to these studies.

FIG. 6A shows an example feature engineering process 600.

Process 600 is implemented or executed using the reservoir characterization engine 205 of system 200, and may also include use of computer systems 124, 1500. More specifically, one or more steps of process 600 are performed using data processing module 220 and NN data model 225. Hence, descriptions of process 600 reference at least data processing module 220 and NN data model 225, and may also reference the resources of computer systems 124, 1500 as well as the other resources of the reservoir characterization engine 205 described in this document. In some implementations, the steps or actions included in process 600 are enabled by programmed firmware or software instructions, which are executable by one or more processors of the devices and resources described in this document.

Process 600 includes computing one or more correlation coefficients (602). For example, the Pearson correlation coefficient of equation (1) is used to measure or compute a correlation between a set of features and a target wireline log for determining one or more predictions.

$${R}_{y x} = \frac{{Σ}_{i = 1}^{m} ( {y}_{i} - \overline{y} ) ( {x}_{i} - \overline{x} )}{\sqrt{{Σ}_{i = 1}^{m} {( {y}_{i} - \overline{y} )}^{2} {Σ}_{i = 1}^{m} {( {x}_{i} - \overline{x} )}^{2}}} \qquad ( 1 )$$

Process 600 includes selecting one or more features (604). For example, the features may be selected from a candidate set of features following computation of the correlation coefficients. From the feature engineering stage some (or all) input logs can be used as features for generating a prediction. For example, a measured depth log, gamma ray log, and compressional sonic log can all be used as input features in a neural network for deep learning for bulk density and shear sonic wireline log predictions.

Process 600 includes performing data augmentation (606). The data augmentation is used to increase a number of input features, for example, from 3 to 9. For example, this augmentation can be done by repeating the initial 3 input logs and shifting them 1 step in depth above and below. The data augmentation can also yield larger or smaller increases. An example of the augmented dataset and the increased number of features is illustrated at FIG. 6C.

In some implementations, the reservoir characterization engine 205 uses a feedback loop to feedback a set of candidate features to the data processing module 220 for data augmentation. In shown in the example of FIG. 2 (described earlier), the reservoir characterization engine 205 also includes a feedback loop 240 where one or more outputs of the NN data model 225 may be fed back to the data processing module 220 as part of the feature engineering process 600. Process 600 includes determining finalized features or one or more finalized feature sets (608).

FIGS. 6B and 6C show example datasets derived from a feature engineering process.

FIG. 6B illustrates an example heat map 620 that shows computed correlation coefficients between the different wireline logs. For example, the heat map 620 includes correlation coefficients for a Depth log (DEPTH), a compressional sonic log (DT), a gamma ray log (GR), and a bulk density log (RHOB). The darker red colors of heat map 620 denote a high positive correlation, whereas the darker blue color denotes a strong negative correlation between the wireline logs. The reservoir characterization engine 205 is operable to conduct similar analysis for shear wireline log predictions and generate a corresponding heat map based on that analysis.

FIG. 6C illustrates an example input feature set 640. In some implementations, feature set 640 is obtained when data augmentation is applied to generate a set of input features. The feature values of feature set 640 are processed as inputs to the neural network to train the neural network to generate bulk density wireline log predictions. The reservoir characterization engine 205 is operable to implement a similar feature engineering procedure to yield features for generating shear wireline log predictions.

FIG. 7 shows an example data splitting process 700. Process 700 is implemented or executed using the reservoir characterization engine 205 of system 200, and may also include use of computer systems 124. More specifically, one or more steps of process 700 are performed using data processing module 220. Hence, descriptions of process 700 reference at least data processing module 220, and may also reference the computing resources of computer systems 124, as well as the other resources of the reservoir characterization engine 205 described earlier in this document. In some implementations, the steps or actions included in process 700 are enabled by programmed firmware or software instructions, which are executable by one or more processors of the devices and resources described in this document.

The data splitting process 700 includes using the data processing module 220 to generate a shuffle dataset (702). Process 700 includes splitting the dataset into training and testing datasets (704). For example, the data processing module 220 can use an example data splitting function to randomly split the shuffle dataset into a training dataset and a testing dataset. The data processing module 220 can also generate a shuffle training dataset (706). The data processing module 220 can then apply the splitting function to re-split the training dataset into training dataset and validation dataset (708).

FIG. 8 shows an example procedure or process 800 for model training and selection. Process 800 is implemented or executed using the reservoir characterization engine 205 of system 200, and may also include use of computer systems 124. More specifically, one or more steps of process 800 are performed using the NN data model 225. Hence, descriptions of process 800 reference at least the NN data model 225, and may also reference the computing resources of computer systems 124, as well as the other resources of the reservoir characterization engine 205 described earlier in this document.

In some implementations, the steps or actions included in process 800 are enabled by programmed firmware or software instructions, which are executable by one or more processors of the devices and resources described in this document. The automated manner in which process 800 can be implemented streamlines the otherwise tedious and time-consuming task of generating a neural network model for predicting wireline logs to enhance or improve performance of reservoir characterization and hydrocarbon production.

Process 800 includes the reservoir characterization engine 205 using at least the NN data model 225 to perform operations for model training and selection. The NN data model 225 (and reservoir characterization engine 205) can use computing logic associated with data analytics and image processing to build, develop, or otherwise generate the NN data model 225. In some implementations, the reservoir characterization engine 205 includes machine-learning logic (or algorithms) for processing inputs obtained from the input dataset 210 that includes sensor or seismic data points. For example, the input data 210 can be a training dataset with one or more labels of seismic data points.

Each data point of the input dataset 210 is processed through one or more neural network layers of a multi-layer neural network in accordance with a set of weights for the neural network layer to generate a machine-learning model (data model 225) corresponding to one or more trained neural networks. The NN data model 225 can be based on one or more neural networks that are trained to compute a certain set of inferences relating to reservoir characterization, to generate a particular set of predictions relating to reservoir characterization, or both. The input data 210 can include multiple inputs that are derived from a wireline log. The reservoir characterization engine 205 can access a predictive neural network model and process the derived inputs through one or more layers of the neural network that represents the predictive model.

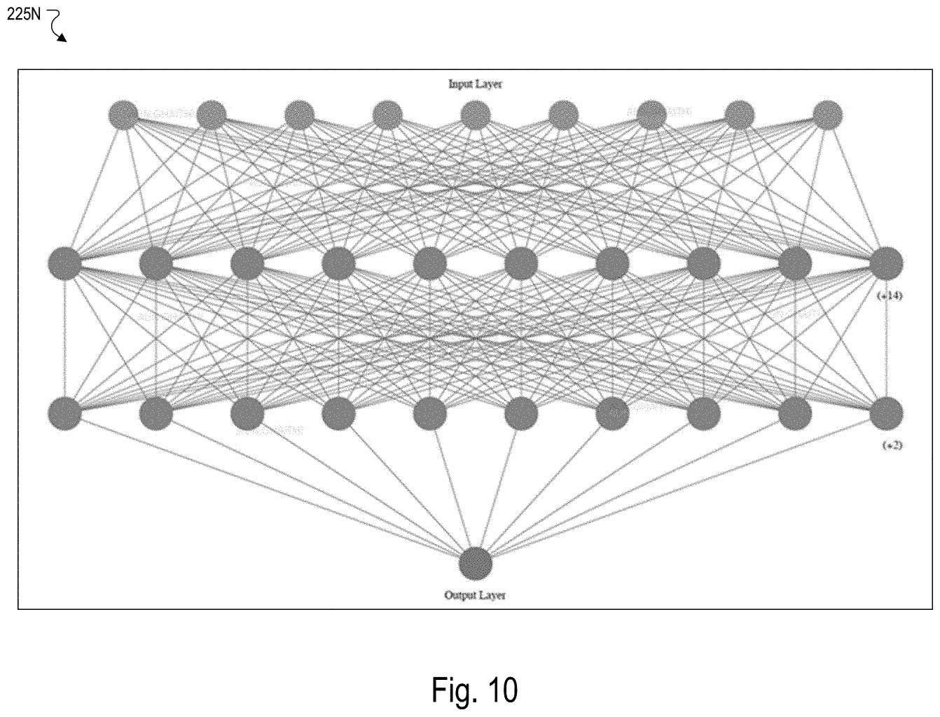

Process 800 includes obtaining a neural network architecture (802). For example, the reservoir characterization engine 205 or other relevant systems described in this document can be used to determine or design a particular neural network architecture. In some implementations, a candidate neural network architecture can be selected from among one or more existing neural network architectures. A representative neural network design/architecture is shown in the example of FIG. 10 (described later). That neural network design shows a feedforward neural network with an input layer in green, two hidden layers in blue, and an output layer in red.

Process 800 includes performing hyper parameter tuning (804). The hyper parameter tuning can be performed in accordance with techniques disclosed throughout this document. In some implementations, the hyperparameters of a neural network that are tuned can include: i) the number of layers in the neural network; ii) the number of neurons per neural network layer; iii) the activation functions that are applied to outputs of a given layer; iv) the optimization scheme(s) that is employed; and v) the learning rate of the neural network.

In some implementations, the reservoir characterization engine 205 uses a stochastic gradient optimizer and a learning rate that is between 0.001 to 0.000001. Other optimizers and learning rates may also be employed. An example number of layers can be 2 to 6 with a varying number of neurons per layer. For example, the number of neurons can range from 5 to 100 neurons. In some cases more or fewer layers and neurons may be used. In some implementations, an example neural network of the reservoir characterization engine 205 utilizes regularization, such as drop or lasso regressors.

Process 800 includes the reservoir characterization engine 205 training one or more of its neural networks using the training dataset (806). For example, the reservoir characterization engine 205 can train its neural network based on one or more of the various training approaches described in this document. Process 800 includes determining, computing, or otherwise estimating an error with respect to the validation data (808). In general, each neural network is trained using a training dataset, whereas an error associated with the neural network is estimated on a validation dataset. In some implementations, this process is iterated until a small (or threshold) amount error is achieved.

Process 800 includes selecting and saving a particular model (810). For example, the reservoir characterization engine 205 can select and save a particular model from among multiple models that are trained. The selected neural network model can be one that meets or exceeds a particular training metric relating to accuracy, latency, or compute speed.

FIG. 9A shows an example process 900 associated with generating a neural network model. Process 900 is implemented or executed using the reservoir characterization engine 205 of system 200, and may also include use of computer systems 124 as well as computer system 1500. Hence, descriptions of process 900 reference at least reservoir characterization engine 205, and may also reference other compute resources and systems described in this document. In some implementations, the steps or actions included in process 900 are enabled by programmed firmware or software instructions, which are executable by one or more processors of the devices and resources described in this document.

As describer earlier, to develop robust models for wireline predictions, the disclosed techniques include a data splitting procedure that splits an expansive dataset into at least: i) a training dataset for training a neural network data model; ii) a validation dataset for use in validating (or evaluating) performance of an initially trained neural network model; and iii) a blind well dataset that is used to further validate overall performance and generalization capabilities of a given neural network model by way of blind well testing. Thus, a neural network data model is trained on the training dataset and tested on the validation dataset.

For example, a neural network architecture provides a basis for a neural network model and hyperparameters of the neural network architecture can require tuning to achieve a desired performance output of the neural network model. In some implementations, the reservoir characterization engine 205 uses the validation dataset to adjust or tune these hyperparameters and to adjust or test neural network architecture designs. In some implementations, process 900 is used to finalize deep-learning model selection. An iterative process is followed to design a neural network that produces robust prediction results.

Process 900 includes performing K-fold cross validation (910). K-fold cross validation is applied to improve the model prediction performance. An example dataset for bulk density wireline log prediction can include 335 wells and the dataset can be randomly split into training data and testing data. In some implementations, 90% of the dataset (302 wells) is used as training wells and 10% of the dataset (33 wells) is used as blind test data. The training data can be randomly re-split into training and validation data. For example, 85% of the 302 wells are used as training and 15% of the 302 wells are used as validation data.

K-fold cross validation is applied against the split and re-split datasets. In some implementations, the 15% of the 302 wells that are used as validation data are rotated. An example of this is shown in the bolded, underlined bins at Table 1, where the bolded, underlined bins (shown diagonally) correspond to validation data and the non-bolded, non-underlined bins correspond to training data. In this example, the reservoir characterization engine 205 selects/uses 7 as the fold for the split. Thus, 7 error values of estimates on the validation data are computed.

TABLE 1
K-fold Cross Validation: Validation Data & Training Data
90% Training Dataset Re-split

| | | | | | | | |
|---|---|---|---|---|---|---|---|
| Split 1 | Fold 1 | Fold 2 | Fold 3 | Fold 4 | Fold 5 | Fold 6 | Fold 7 |
| Split 2 | Fold 1 | Fold 2 | Fold 3 | Fold 4 | Fold 5 | Fold 6 | Fold 7 |
| Split 3 | Fold 1 | Fold 2 | Fold 3 | Fold 4 | Fold 5 | Fold 6 | Fold 7 |
| Split 4 | Fold 1 | Fold 2 | Fold 3 | Fold 4 | Fold 5 | Fold 6 | Fold 7 |
| Split 5 | Fold 1 | Fold 2 | Fold 3 | Fold 4 | Fold 5 | Fold 6 | Fold 7 |
| Split 6 | Fold 1 | Fold 2 | Fold 3 | Fold 4 | Fold 5 | Fold 6 | Fold 7 |
| Split 7 | Fold 1 | Fold 2 | Fold 3 | Fold 4 | Fold 5 | Fold 6 | Fold 7 |

A similar, corresponding approach can be conducted for shear prediction based on a similarly sized dataset for shear wireline log prediction. For example, a total of 170 wells can be split into: i) 153 wells that are used for training and ii) 17 wells that are used as blind test data. The 153 training wells can be also re-split to perform K-fold cross validation as described in the preceding paragraphs.

The process 900 includes an example error analysis operation (912). The reservoir characterization engine 205 can perform the error analysis against one or more of the datasets that are derived from the data splitting operation. For example, reservoir characterization engine 205 can perform error analysis on prediction outputs obtained using validation data such that the error outputs are estimated on the hold-out validation dataset. In some implementations, error analysis is done on the validation dataset and cross validation is applied to obtain multiple estimates of the error and measure the performance of the deep learning model.

As discussed earlier, the process of model training and error analysis can be iterated until a small (or threshold) amount error is achieved. The reservoir characterization engine 205 is operable to analyze error outputs to detect that an acceptable error threshold has been reached. The reservoir characterization engine 205 can select the neural network architecture and associated parameters in response to detecting the acceptable error threshold. In some implementations, a model is re-trained on the full training dataset. The results of the re-training is observed to determine if a particular iteration of the neural network model should be saved for subsequent deployment.

The reservoir characterization engine 205 can use quantitative metrics to evaluate the deep-learning model performance. The quantitative metrics can be computed based on the following equations.

$$M S E = {\sum }_{i = 1}^{m} \frac{{( {\hat{y}}_{i} - {y}_{i} )}^{2}}{m} \qquad ( 2 )$$

$$R M S E = \sqrt{{\sum }_{i = 1}^{m} \frac{{( {\hat{y}}_{i} - {y}_{i} )}^{2}}{m}} \qquad ( 3 )$$

$${R}^{2} = \frac{{Σ}_{i = 1}^{m} {( {\hat{y}}_{i} - \overline{y} )}^{2}}{{Σ}_{i = 1}^{m} {( {y}_{i} - \overline{y} )}^{2}} \qquad ( 4 )$$

$${R}_{y x} = \frac{{Σ}_{i = 1}^{m} ( {y}_{i} - \overline{y} ) ( {x}_{i} - \overline{x} )}{\sqrt{{Σ}_{i = 1}^{m} {( {y}_{i} - \overline{y} )}^{2} {Σ}_{i = 1}^{m} {( {x}_{i} - \overline{x} )}^{2}}} \qquad ( 5 )$$

$$M A E = {\sum }_{i = 1}^{m} \vert \frac{{\hat{y}}_{i} - {y}_{i}}{m} \vert \qquad ( 6 )$$

$$M A P E = {\sum }_{i = 1}^{m} \frac{\vert \frac{{\hat{y}}_{i} - {y}_{i}}{{y}_{i}} \vert}{m} \qquad ( 7 )$$

For example, a mean squared error (MSE) squares the errors between the predicted log value ŷᵢ and the actual log value yⱼ and then calculates the mean. The root mean squared error (RMSE) is the squared root of the MSE and gives a calculation of the same scale as the original errors. A coefficient of determination R² is used to compute an estimate of how much of the wireline data variability is accounted for. A Pearson correlation coefficient R_{yx} is used to obtain a measure of correlation between the actual and predicted values. The mean absolute error (MAE) and mean absolute percentage error (MAPE) are also used. The MAPE gives an idea of the size of the error compared to the actual value.

Process 900 includes a decision block for determining whether an observed error is acceptable (914). For example, the process of neural network design, hyperparameter tuning, model training, and error analysis can be iterated until a small (or threshold) amount error is achieved. When the reservoir characterization engine 205 selects a neural network model (916), such as a final neural network model, that model is once again tested on the blind well testing dataset.

Process 900 includes the reservoir characterization engine 205 training one or more of its neural networks on the full training dataset (918). Process 900 includes selecting and saving a particular trained neural network model (920). For example, the reservoir characterization engine 205 can select and save a neural network model that meets or exceeds a particular training metric (or threshold) relating to observed error, accuracy, latency, or compute speed.

FIG. 9B illustrates a graphical output 950 that shows example normalized mean squared error loss curve from training a neural network on a full training dataset. In some implementations, graphical output 950 corresponds to the error analysis computations described earlier with reference to process 900.

FIG. 10 illustrates an example feed-forward neural network architecture 225N. The architecture 225N includes multiple neural network layers. In the example of FIG. 10, the architecture 225N includes an input layer, an output layer, and one or more intermediate layers.

FIG. 11A illustrates example graphical data 1105 from a representative blind well test. More specifically, graphical data 1105 includes data corresponding to a prediction for shear wireline log (DTSM-DL) and data corresponding to a measured shear wireline log (DTSM). Graphical data 1105 includes a blue curve and a red curve. The blue curve indicates the predicted wireline log, whereas the red curve indicates the measured wireline log. Graphical data 1105 shows that the predicted wireline log is generally consistent with the measured wireline log.

FIG. 11B illustrates example graphical data from a representative blind well test for shear log predictions. More specifically, graphical data 1110 also includes data corresponding to a prediction for shear wireline log (DTSM-DL) and data corresponding to a measured shear wireline log (DTSM). Much like graphical data 1105 of FIG. 11A, graphical data 1110 also includes a blue curve and a red curve. The blue curve of data 1110 indicates the predicted shear wireline log, whereas the red curve indicates the measured wireline log.

As noted earlier, the examples of FIG. 11A and FIG. 11B show results of blind well tests for shear log predictions. In those examples, the various quantitative methods for error analysis that are disclosed in this document can be used to evaluate the results of the various blind well tests. In some implementations, the results corresponding to the blind well tests of FIGS. 11A and 11B utilized a coefficient of determination (R-squared) value of 0.94 and 0.86, respectively.

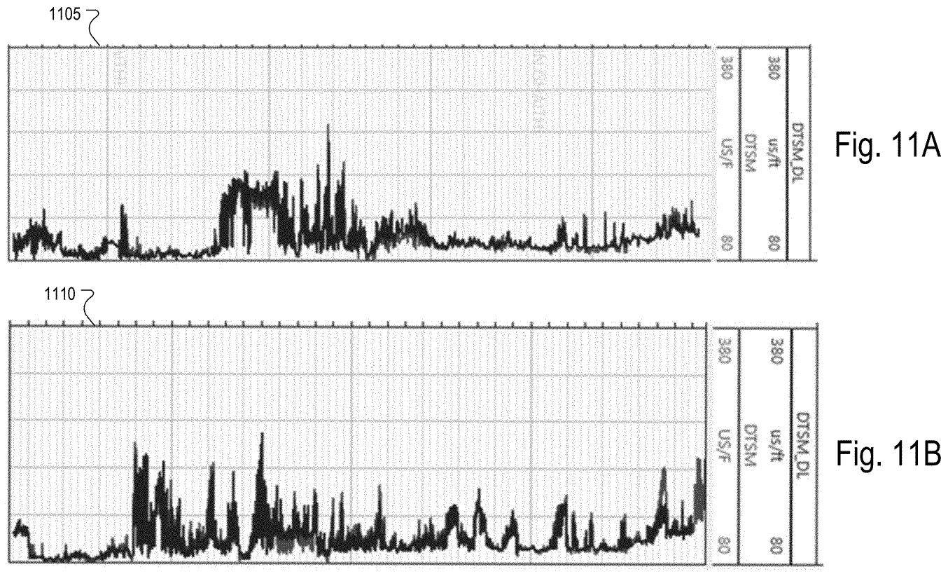

FIGS. 12A and 12B illustrate example graphical data from a representative blind well test for bulk density log predictions. More specifically, each of graphical data 1205 of FIG. 12A and graphical data 1210 of FIG. 12B includes data corresponding to a prediction for bulk density wireline logs (RHOB-DL) and data corresponding to a measured bulk density wireline log (RHOB). Graphical data 1205 and 1210 includes a blue curve and a red curve. In each of graphical data 1205, 1210 the blue curve indicates the predicted bulk density wireline log, whereas the red curve indicates the measured bulk density wireline log. Each of graphical data 1205, 1210 shows that the predicted wireline log is generally consistent with the measured wireline log.

As noted earlier, the examples of FIG. 12A and Error! Reference source not found. FIG. 12B show the neural network model (e.g., model 225) prediction results of blind well tests for bulk density wireline log predictions. In those examples, the prediction accuracy is 0.77 and 0.85, respectively. The example of FIG. 12A includes a graph section 1215 that indicates results that are less accurate relative to other graph sections. The results are less accurate at section 1215 due to a fewer number of wells with deep penetrations in the training dataset. Nonetheless, the data at graph sections other than section 1215 indicate more accurate, robust predictions that provide a reliable trend of the true well log.

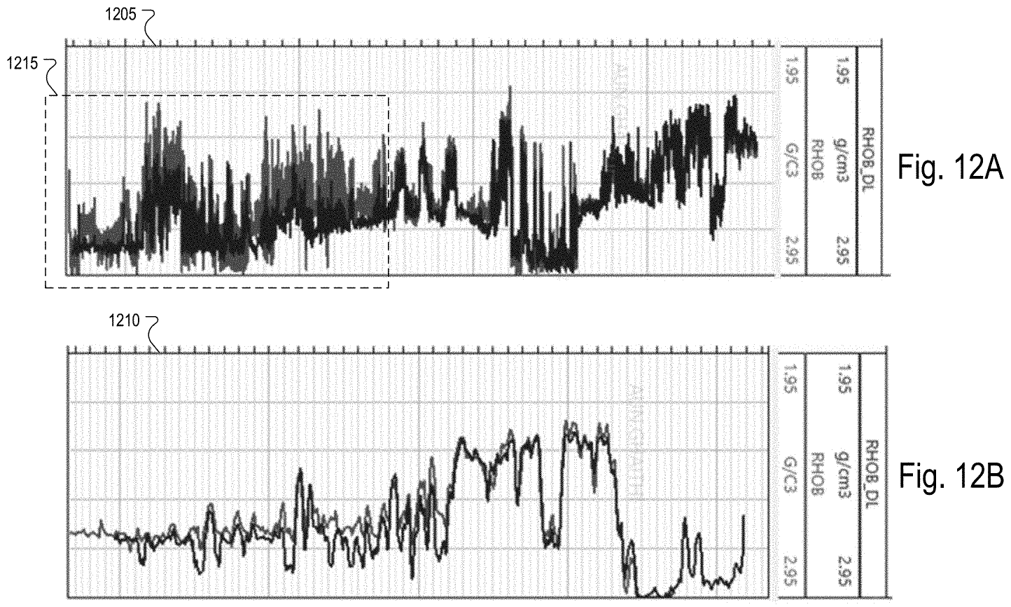

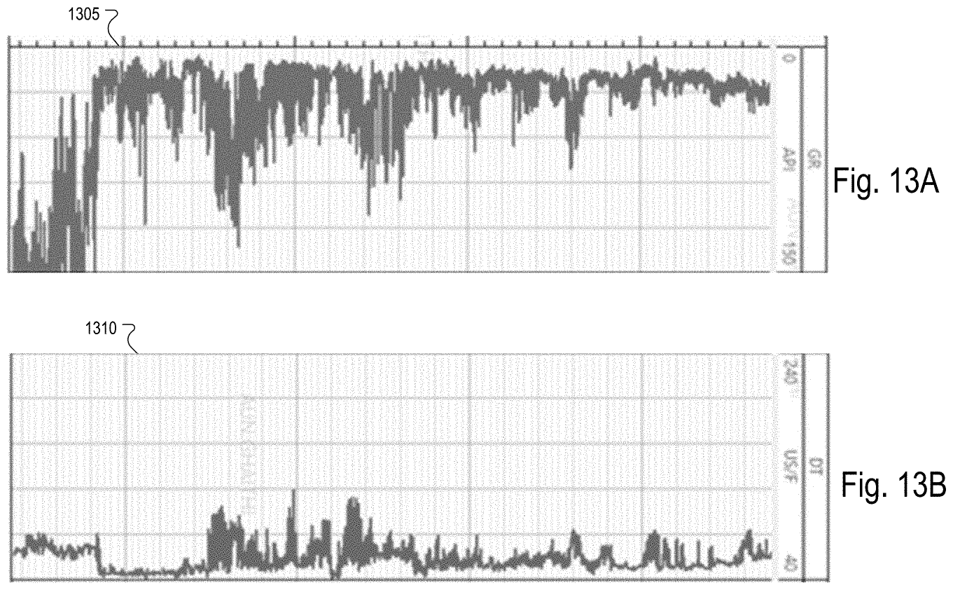

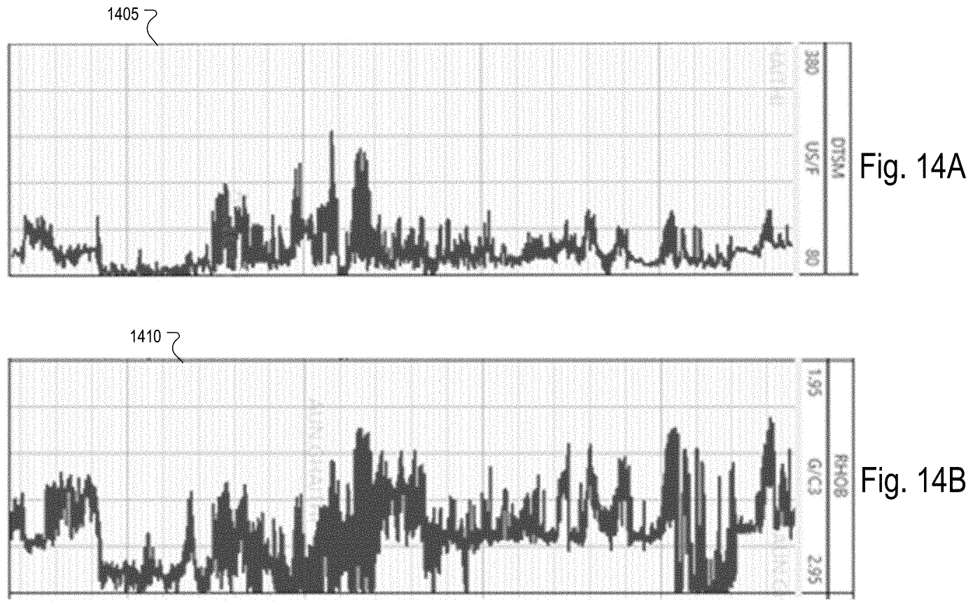

FIGS. 13A and 13B illustrate example graphical representations of data used to generate one or more machine-learning predictions. More specifically, graphical data 1305 of FIG. 13A shows an example gamma ray log (GR) in green, whereas graphical data 1310 of FIG. 13B shows an example sonic log (DT) in magenta. FIGS. 14A and 14B illustrate example machine-learning predictions generated for one or more log datasets. More specifically, graphical data 1405 of FIG. 14A shows an example prediction for a shear wireline log (indicated as DTSM), whereas graphical data 1410 of FIG. 14B shows an example prediction for a bulk density wireline log (indicated as RHOB).

Each of the data values represented by graphical data 1305, GR, and graphical data 1310, DT, are processed or otherwise used in a deep learning model to generate the shear wireline log (DTSM) prediction and the bulk density wireline log (RHOB) prediction. Each of the DTSM prediction (1405) and the RHOB prediction (1410) are illustrated in red at FIG. 14A and FIG. 14B, respectively.

FIG. 1500 is a block diagram of an example computer system 1500 used to provide computational functionalities associated with described algorithms, methods, functions, processes, flows, and procedures described in the present disclosure, according to some implementations of the present disclosure.

The illustrated computer 1502 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1502 can include input devices such as keypads, keyboards, and touch screens that can accept user information. Also, the computer 1502 can include output devices that can convey information associated with the operation of the computer 1502. The information can include digital data, visual data, audio information, or a combination of information. The information can be presented in a graphical user interface (UI) (or GUI).

The computer 1502 can serve in a role as a client, a network component, a server, a database, a persistency, or components of a computer system for performing the subject matter described in the present disclosure. The illustrated computer 1502 is communicably coupled with a network 1530. In some implementations, one or more components of the computer 1502 can be configured to operate within different environments, including cloud-computing-based environments, local environments, global environments, and combinations of environments.

At a high level, the computer 1502 is an electronic computing device operable to receive, transmit, process, store, and manage data and information associated with the described subject matter. According to some implementations, the computer 1502 can also include, or be communicably coupled with, an application server, an email server, a web server, a caching server, a streaming data server, or a combination of servers.

The computer 1502 can receive requests over network 1530 from a client application (for example, executing on another computer 1502). The computer 1502 can respond to the received requests by processing the received requests using software applications. Requests can also be sent to the computer 1502 from internal users (for example, from a command console), external (or third) parties, automated applications, entities, individuals, systems, and computers.

Each of the components of the computer 1502 can communicate using a system bus 1503. In some implementations, any or all of the components of the computer 1502, including hardware or software components, can interface with each other or the interface 1504 (or a combination of both), over the system bus 1503. Interfaces can use an application programming interface (API) 1512, a service layer 1513, or a combination of the API 1512 and service layer 1513. The API 1512 can include specifications for routines, data structures, and object classes. The API 1512 can be either computer-language independent or dependent. The API 1512 can refer to a complete interface, a single function, or a set of APIs.

The service layer 1513 can provide software services to the computer 1502 and other components (whether illustrated or not) that are communicably coupled to the computer 1502. The functionality of the computer 1502 can be accessible for all service consumers using this service layer. Software services, such as those provided by the service layer 1513, can provide reusable, defined functionalities through a defined interface. For example, the interface can be software written in JAVA, C++, or a language providing data in extensible markup language (XML) format. While illustrated as an integrated component of the computer 1502, in alternative implementations, the API 1512 or the service layer 1513 can be stand-alone components in relation to other components of the computer 1502 and other components communicably coupled to the computer 1502. Moreover, any or all parts of the API 1512 or the service layer 1513 can be implemented as child or sub-modules of another software module, enterprise application, or hardware module without departing from the scope of the present disclosure.

The computer 1502 includes an interface 1504. Although illustrated as a single interface 1504 in FIG. 15, two or more interfaces 1504 can be used according to particular needs, desires, or particular implementations of the computer 1502 and the described functionality. The interface 1504 can be used by the computer 1502 for communicating with other systems that are connected to the network 1530 (whether illustrated or not) in a distributed environment. Generally, the interface 1504 can include, or be implemented using, logic encoded in software or hardware (or a combination of software and hardware) operable to communicate with the network 1530. More specifically, the interface 1504 can include software supporting one or more communication protocols associated with communications. As such, the network 1530 or the hardware of the interface can be operable to communicate physical signals within and outside of the illustrated computer 1502.

The computer 1502 includes a processor 1505. Although illustrated as a single processor 1505 in FIG. 15, two or more processors 1505 can be used according to particular needs, desires, or particular implementations of the computer 1502 and the described functionality. Generally, the processor 1505 can execute instructions and can manipulate data to perform the operations of the computer 1502, including operations using algorithms, methods, functions, processes, flows, and procedures as described in the present disclosure.

The computer 1502 also includes a database 1506 that can hold data (for example, seismic data 1516) for the computer 1502 and other components connected to the network 1530 (whether illustrated or not). For example, database 1506 can be an in-memory, conventional, or a database storing data consistent with the present disclosure. In some implementations, database 1506 can be a combination of two or more different database types (for example, hybrid in-memory and conventional databases) according to particular needs, desires, or particular implementations of the computer 1502 and the described functionality. Although illustrated as a single database 1506 in FIG. 15, two or more databases (of the same, different, or combination of types) can be used according to particular needs, desires, or particular implementations of the computer 1502 and the described functionality. While database 1506 is illustrated as an internal component of the computer 1502, in alternative implementations, database 1506 can be external to the computer 1502.

The computer 1502 also includes a memory 1507 that can hold data for the computer 1502 or a combination of components connected to the network 1530 (whether illustrated or not). Memory 1507 can store any data consistent with the present disclosure. In some implementations, memory 1507 can be a combination of two or more different types of memory (for example, a combination of semiconductor and magnetic storage) according to particular needs, desires, or particular implementations of the computer 1502 and the described functionality. Although illustrated as a single memory 1507 in FIG. 15, two or more memories 1507 (of the same, different, or combination of types) can be used according to particular needs, desires, or particular implementations of the computer 1502 and the described functionality. While memory 1507 is illustrated as an internal component of the computer 1502, in alternative implementations, memory 1507 can be external to the computer 1502.

The application 1508 can be an algorithmic software engine providing functionality according to particular needs, desires, or particular implementations of the computer 1502 and the described functionality. For example, application 1508 can serve as one or more components, modules, or applications. Further, although illustrated as a single application 1508, the application 1508 can be implemented as multiple applications 1508 on the computer 1502. In addition, although illustrated as internal to the computer 1502, in alternative implementations, the application 1508 can be external to the computer 1502.

The computer 1502 can also include a power supply 1514. The power supply 1514 can include a rechargeable or non-rechargeable battery that can be configured to be either user- or non-user-replaceable. In some implementations, the power supply 1514 can include power-conversion and management circuits, including recharging, standby, and power management functionalities. In some implementations, the power-supply 1514 can include a power plug to allow the computer 1502 to be plugged into a wall socket or a power source to, for example, power the computer 1502 or recharge a rechargeable battery.

There can be any number of computers 1502 associated with, or external to, a computer system containing computer 1502, with each computer 1502 communicating over network 1530. Further, the terms “client,” “user,” and other appropriate terminology can be used interchangeably, as appropriate, without departing from the scope of the present disclosure. Moreover, the present disclosure contemplates that many users can use one computer 1502 and one user can use multiple computers 1502.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus.

Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC).

In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment.

A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network.

While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing.

Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship. Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

What is claimed is:

1. A method for managing operations involving a well in a subsurface region using a neural network implemented on a hardware integrated circuit, the method comprising:
deriving a plurality of inputs from one or more first wireline logs;
accessing a predictive model comprising a neural network trained to generate one or more data predictions;
processing, at the predictive model, the plurality of inputs derived from the one or more first wireline logs through one or more layers of the neural network;
generating, by the predictive model, a prediction identifying a plurality of second wireline logs for a reservoir in the subsurface region based on the processing of the plurality of inputs; and
controlling, based on the plurality of second wireline logs, well drilling operations that simulate hydrocarbon production at the reservoir.

2. The method of claim 1, wherein generating the prediction identifying the plurality of second wireline logs comprises:
generating a shear-slowness wireline log that is based on the one or more first wireline logs; and
generating a bulk-density wireline log that is based on the one or more first wireline logs.

3. The method of claim 2, further comprising:
computing, using the predictive model, characterizations of the reservoir in the subsurface region based on a predicted shear-slowness wireline log and a predicted bulk-density wireline log included among the plurality of second wireline logs.

4. The method of claim 2, further comprising:
determining, by the predictive model, a plurality of earth properties for an area of the subsurface region that includes the reservoir; and
determining, by the predictive model, a characteristic of the reservoir in the subsurface region based on the plurality of earth properties.

5. The method of claim 4, wherein determining the plurality of earth properties comprises:
calculating a set of mechanical earth properties based on at least one of the plurality of second wireline logs; and
calculating a set of elastic earth properties based on at least one of the plurality of second wireline logs.

6. The method of claim 5, wherein the set of mechanical earth properties and the set of elastic earth properties comprises one or more of:
a Young's modulus, a bulk modulus, a shear modulus, and a Poisons ratio.

7. The method of claim 5, further comprising:
computing, from computed outputs of the predictive model, characterizations of the reservoir in the subsurface region based on at least one of:
the set of mechanical earth properties; or
the set of elastic earth properties.

8. The method of claim 7, wherein computing characterizations of the reservoir comprises:
identifying a stiffness of porous fluid saturated rocks at the reservoir based on the set of mechanical earth properties and the set of elastic earth properties.

9. The method of claim 8, wherein identifying a stiffness of porous fluid saturated rocks at the reservoir comprises:
identifying the stiffness based on elastic moduli that identify stiffer rocks in unconventional oil and gas reservoirs.

10. The method of claim 7, further comprising:
determining, using the predictive model, a placement location for a well drilling operation based on the computed characterizations of the reservoir.

11. The method of claim 10, wherein controlling the well drilling operations comprises:
causing a hydraulic fracture at the placement location; and
stimulating a particular type of hydrocarbon production at the reservoir in response to causing the hydraulic fracture at the placement location.

12. A system for managing operations involving a well in a subsurface region using a neural network implemented on a hardware integrated circuit of the system,
the system comprising a processor and a non-transitory machine-readable storage device storing instructions that are executable by the processor to perform operations comprising:
deriving a plurality of inputs from one or more first wireline logs;
accessing a predictive model comprising a neural network trained to generate one or more data predictions;
processing, at the predictive model, the plurality of inputs derived from the one or more first wireline logs through one or more layers of the neural network;
generating, by the predictive model, a prediction identifying a plurality of second wireline logs for a reservoir in the subsurface region based on the processing of the plurality of inputs; and
controlling, based on the plurality of second wireline logs, well drilling operations that simulate hydrocarbon production at the reservoir.

13. The system of claim 12, wherein generating the prediction identifying the plurality of second wireline logs comprises:
generating a shear-slowness wireline log that is based on the one or more first wireline logs; and
generating a bulk-density wireline log that is based on the one or more first wireline logs.

14. The system of claim 13, wherein the operations further comprise:
computing, using the predictive model, characterizations of the reservoir in the subsurface region based on a predicted shear-slowness wireline log and a predicted bulk-density wireline log included among the plurality of second wireline logs.

15. The system of claim 13, wherein the operations further comprise:
determining, by the predictive model, a plurality of earth properties for an area of the subsurface region that includes the reservoir; and
determining, by the predictive model, a characteristic of the reservoir in the subsurface region based on the plurality of earth properties.

16. The system of claim 15, wherein determining the plurality of earth properties comprises:
calculating a set of mechanical earth properties based on at least one of the plurality of second wireline logs; and
calculating a set of elastic earth properties based on at least one of the plurality of second wireline logs.

17. The system of claim 16, wherein the set of mechanical earth properties and the set of elastic earth properties comprises one or more of:
a Young's modulus, a bulk modulus, a shear modulus, and a Poisons ratio.

18. The system of claim 16, wherein the operations further comprise:
computing, from computed outputs of the predictive model, characterizations of the reservoir in the subsurface region based on at least one of:
the set of mechanical earth properties; or
the set of elastic earth properties.

19. The system of claim 18, wherein computing characterizations of the reservoir comprises:
identifying a stiffness of porous fluid saturated rocks at the reservoir based on the set of mechanical earth properties and the set of elastic earth properties.

20. The system of claim 19, wherein identifying a stiffness of porous fluid saturated rocks at the reservoir comprises:
identifying the stiffness based on elastic moduli that identify stiffer rocks in unconventional oil and gas reservoirs.

21. The system of claim 18, wherein the operations further comprise:
determining, using the predictive model, a placement location for a well drilling operation based on the computed characterizations of the reservoir.

22. The system of claim 21, wherein controlling the well drilling operations comprises:
causing a hydraulic fracture at the placement location; and
stimulating a particular type of hydrocarbon production at the reservoir in response to causing the hydraulic fracture at the placement location.

23. A non-transitory machine-readable device storing instructions for managing drilling operations at a subsurface region using a neural network implemented on a hardware integrated circuit, the instructions being executable by a processor to perform operations comprising:
deriving a plurality of inputs from one or more first wireline logs;
accessing a predictive model comprising a neural network trained to generate one or more data predictions;
processing, at the predictive model, the plurality of inputs derived from the one or more first wireline logs through one or more layers of the neural network;
generating, by the predictive model, a prediction identifying a plurality of second wireline logs for a reservoir in the subsurface region based on the processing of the plurality of inputs; and
controlling, based on the plurality of second wireline logs, well drilling operations that simulate hydrocarbon production at the reservoir.
